(19) United States
(12) Patent Application Publication
(10) Pub. No.: US 2010/0190597 A1
(43) Pub. Date: Jul. 29, 2010

(54) Pulley for a Cableway System and Set of Pulleys for Producing a Belt Drive

(75) Inventor: GÜNTHER FINK, HITTISAU (AT)

Correspondence Address: LERNER GREENBERG STEMER LLP, P O BOX 2480, HOLLYWOOD, FL, 33022-2480, US

(73) Assignee: Innova Patent GmbH, Wolfurt (AT)

(21) Appl. No.: 12/640,841

(22) Filed: Dec. 17, 2009

(30) Foreign Application Priority Data
Jan. 29, 2009 (AT) 158/2009
Apr. 2, 2009 (AT) 528/2009

(51) Int. Cl. F16H 55/49; F16H 55/36

(52) U.S. Cl. 474/169; 474/166; 474/168

(57) ABSTRACT

A pulley for the production of a belt drive, in particular for driving deceleration wheels, conveying wheels and acceleration wheels in cableway systems, is formed in its central region with a hub for connecting it to a drive shaft and at its periphery with an annular belt surface, in particular a groove, for a drive belt or the like. The pulley consists of sheet steel and the belt surface provided on its periphery thereof is produced by splitting the rim of the pulley.

### CROSS-REFERENCE TO RELATED APPLICATION

This application claims the priority, under 35 U.S.C. §119, of Austrian patent application A 158/2009, filed Jan. 29, 2009, and Austrian patent application A 528/2009, filed Apr. 2, 2009; the prior applications are herewith incorporated by reference in their entirety.

### BACKGROUND OF THE INVENTION

### Field of the Invention

The present invention relates to a pulley for a belt drive, in particular for driving deceleration wheels, conveying wheels and acceleration wheels in cableway systems, which pulley is formed in its central region with a hub for connecting it to a drive shaft and at its periphery with at least one annular belt surface, in particular a groove, for a drive belt or the like.

Furthermore, the present invention relates to a set for producing pulleys for a belt drive.

In cableway systems with couplable vehicles, it is known to guide the vehicles along guide rails through the stations. When the vehicles enter a cableway station, they are decoupled from the carrying and conveying cable, which is moved for example at a speed of 6 m/sec. At that point their speed is reduced by way of deceleration wheels compared with the speed of the carrying and conveying cable. As a result, the vehicles are moved through the boarding and disembarking region, where the passengers disembark from and/or embark the vehicles, by means of conveying wheels at a constant loading speed of, say, 0.2 m/sec to 1 m/sec. Subsequently, the vehicles are accelerated by means of acceleration wheels to the speed of the carrying and conveying cable, whereupon they are once again coupled to the carrying and conveying cable and are moved thereby into the next cableway station.

The deceleration wheels, conveying wheels and acceleration wheels for moving the vehicles through the cableway stations are driven by means of a multiplicity of pairs of pulleys which are arranged along the guide path of the vehicles and are connected to drive shafts on which deceleration wheels, conveying wheels and acceleration wheels, which interact with the running-gear mechanisms of the vehicles, are located. The two pulleys are in this case formed with in each case at least one belt surface for a drive belt, the two pulleys assigned to one another and following one another in the movement path of the vehicles being rotationally coupled to one another by means of the drive belts. In order to achieve the movement sequence desired in each case, the belt surfaces of the two pulleys have identical or different diameters. If a first pulley has a smaller diameter than the second pulley coupled to it, the second pulley is rotated at a slower speed than the first pulley, as a result of which the drive wheels, rotated by these pulleys, for the vehicles are rotated at a decreasing speed, that is to say these drive wheels act as deceleration wheels. If the two pulleys coupled by means of the drive belts have identical diameters, the drive wheels, rotated by these pulleys, for the vehicles are rotated at the same speed, as a result of which the drive wheels, rotated by these pulleys, for the vehicles are moved at a constant speed. If a first pulley has a larger diameter than the second pulley coupled to it, the second pulley is rotated at a faster speed than the first pulley, as a result of which the drive wheels rotated by these pulleys are moved at an increasing speed, that is to say these wheels act as acceleration wheels.

Prior art pairs of pulleys which are formed with in each case at least two belt surfaces and consist of a metal such as iron or aluminum are produced in a casting operation, in which case they must be machined. Since a multiplicity of different diameters of the respective belt surfaces are required for different structural designs or for different movement sequences, the production of such prior art pulleys is very complex owing to the multiplicity of different sizes thereof.

### SUMMARY OF THE INVENTION

It is accordingly an object of the invention to provide a belt pulley for an aerial cableway installation and a kit for producing the same which overcomes the above-mentioned disadvantages of the heretofore-known devices and methods of this general type and which provides for a pulley that can be produced with less complexity than is the case for pulleys produced in a casting operation.

With the foregoing and other objects in view there is provided, in accordance with the invention, a pulley for a belt drive, comprising:

a pulley body formed of sheet steel, the pulley body having:

a hub, forming a central region of the pulley, for connecting the pulley to a drive shaft;

an annular belt surface, forming a periphery of the pulley, for engagement of a drive belt;

the annular belt surface being formed by a split rim of the pulley body, formed by splitting a periphery of the sheet steel along the rim thereof, to form a groove or the like, such as a V-groove.

The novel pulley is particulary suited for driving deceleration wheels, conveying wheels, and acceleration wheels in a cableway system.

In other words, the objects are achieved according to the invention in that the pulley consists of sheet steel and in that the belt surface provided on the periphery thereof is produced by splitting the rim of the pulley.

Preferably, the central region of the pulley is formed with a bulge by means of which it can be fitted on a radial flange of the drive shaft. In this case, the depth of the bulge in the axial direction is preferably approximately half the width of the belt surface for the drive belt. In order to form a belt drive, two pulleys are brought into abutment along the lateral surfaces of the bulges and the adjacent pulleys are connected to one another by means of axially directed bolts.

Furthermore, the pulley is preferably formed firstly with a through-opening and secondly with an inscription, which can be seen through the opening in the adjoining pulley.

A set of pulleys for producing a belt drive in a cableway system consists of a multiplicity of pulleys made of sheet steel, which have different diameters and which are formed with a belt surface produced by splitting the circumferential rim, in which case they can be optionally connected to one another.

Other features which are considered as characteristic for the invention are set forth in the appended claims.

Although the invention is illustrated and described herein as embodied in a pulley for a cableway system and set for producing it, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an axonometric representation of a cableway system station with couplable vehicles in the form of gondolas;

FIG. 2 shows a diagrammatic top view representation of the pulleys arranged in pairs and the drive wheels rotationally connected thereto for the vehicles moved through these cableway stations in order to explain the movement sequence of the vehicles;

FIG. 3 is a plan view of a pulley;

FIG. 3A is a cross-section taken along the line III-III in FIG. 3 and viewed in the direction of the arrows;

FIG. 3B is a perspective view a pulley according to the invention;

FIGS. 4, 4A, and 4B are each a side view and a cross section of three pairs of pulleys with in each case one belt surface; and

FIGS. 5, 5A, and 5B are each a side view and a cross section of three pairs of pulleys with in each case two belt surfaces.

### DETAILED DESCRIPTION OF THE INVENTION

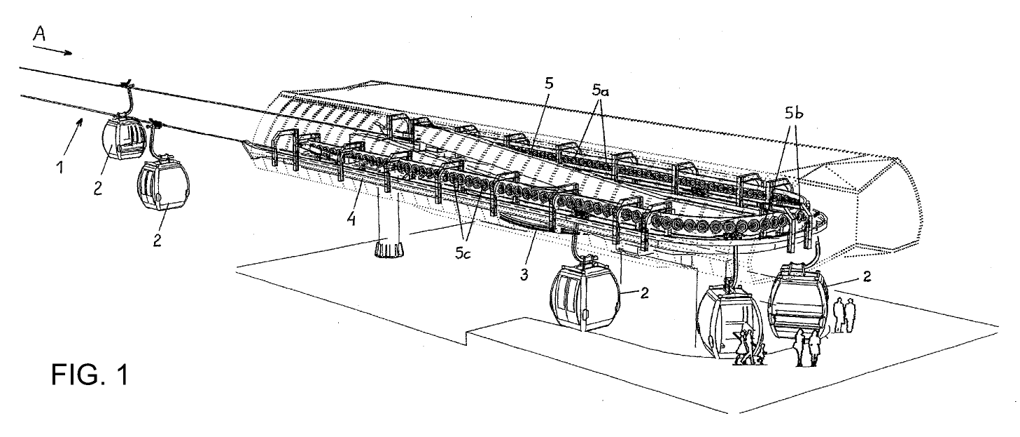

Referring now to the figures of the drawing in detail and first, particularly, to FIG. 1 thereof, there is shown one of the stations of a cableway system with vehicles 2, here in the form of gondolas, which can be coupled to a carrying and conveying cable 1. This station contains a deflecting pulley 3, also referred to as a bullwheel, for the carrying and conveying cable 1, which is being moved at a constant speed of for example 6 m/sec. The vehicles moved into the station in the direction of the arrow A by means of the carrying and conveying cable 1 are decoupled from the carrying and conveying cable 1 and moved through the station along a guide rail 4 by means of drive wheels 5. The wheels 5 include a set of deceleration wheels 5a, a set of conveying wheels 5b, and a set of acceleration wheels 5c. By means of the deceleration wheels 5a, the vehicles 2 are decelerated from the speed of the carrying and conveying cable 1 to a speed of, say, 0.2 m/sec to 1 m/sec, at which speed they are moved through a boarding and disembarking region for the passengers by means of the conveying wheels 5b. In this region, through which they are moved at a constant speed, passengers leave the vehicles 2 or enter the vehicles 2. Subsequently, the vehicles 2 are accelerated to the speed of the carrying and conveying cable 1 by way of the acceleration wheels 5c, whereupon they are coupled to said carrying and conveying cable 1 again and are conveyed by the cable 1 out of the cableway station and on to a further station.

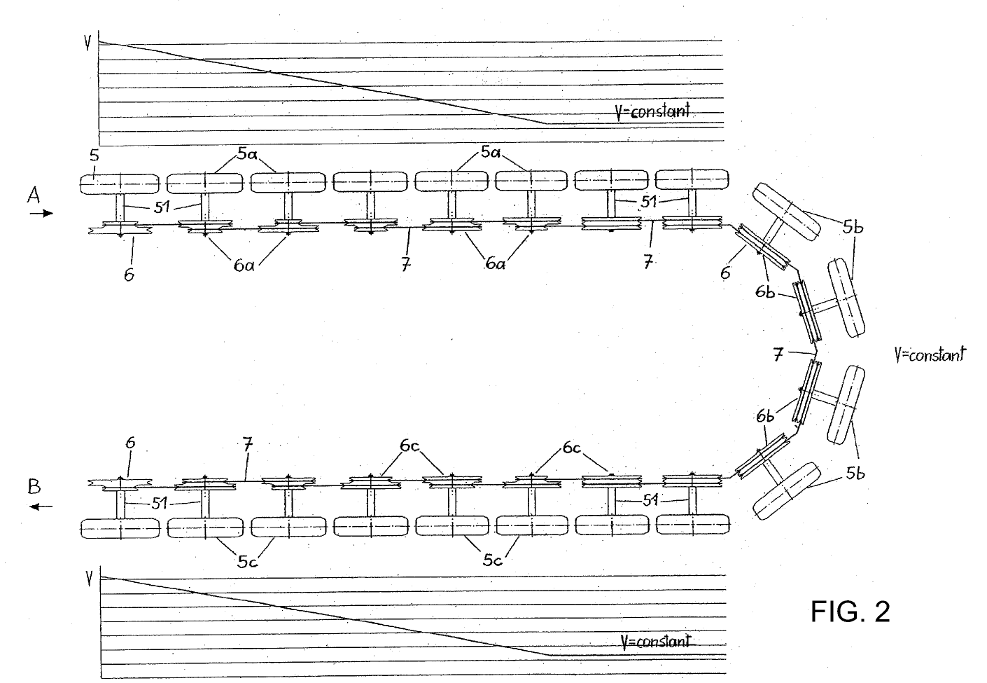

FIG. 2 shows a diagrammatic representation of the drive wheels 5, specifically the deceleration wheels 5a, the conveying wheels 5b, the acceleration wheels 5c, and the pairs of pulleys 6, and also, in schematic fashion, the speeds V of the vehicles in the cableway station.

The drive wheels 5 are mounted on drive shafts 51 of pairs of pulleys 6, which are formed by two pulleys of identical or mutually different diameters with annular belt surfaces for drive belts 7 provided in each case between two successive pairs of pulleys 6. In this case, the first pulleys located in each case in the direction of movement A of the vehicles, i.e., the upstream pulleys, have smaller diameters than the second pulleys coupled to them, as a result of which the pairs of pulleys 6a following in each case and the drive wheels 5a rotated by them are rotated at decreasing speeds, meaning that these drive wheels 5a act as deceleration wheels for the vehicles. Accordingly, the speed at which the vehicles are moved in this region of the cableway station decreases as the vehicles progress forward.

Pairs of pulleys 6b are also provided, the pulleys of which have identical diameters, as a result of which the conveying wheels 5b driven by them are rotated at a constant speed and thus the vehicles are moved at a constant speed through the boarding and disembarking region for the passengers, where they are entered and left by them.

Pairs of pulleys 6c are also provided, the pulleys of which once again have different diameters, the diameters of the pulleys coupled to one another by means of the drive belts 7 being in each case larger than the diameters of the following pulleys, as a result of which the drive wheels 5c, coupled with these pairs of pulleys 6c, for the vehicles are rotated at increasing speeds, as a result of which they act as acceleration wheels for the vehicles. By means of these drive wheels 5c, the vehicles are accelerated to the speed of the carrying and conveying cable, whereupon they are coupled to said carrying and conveying cable and are conveyed by it out of the cableway station in the direction of the arrow B.

The structural designs explained with reference to FIGS. 1 and 2 are known from the prior art. In the prior art cableway systems, the individual pulleys are produced in a casting operation. Since the individual pulleys have a multiplicity of different diameters, it is necessary to produce a multiplicity of differently formed pulleys, for which a multiplicity of casting dies are necessary. In addition, these pulleys have to be machined after the casting process. There is thus a desire to produce such pulleys more inexpensively.

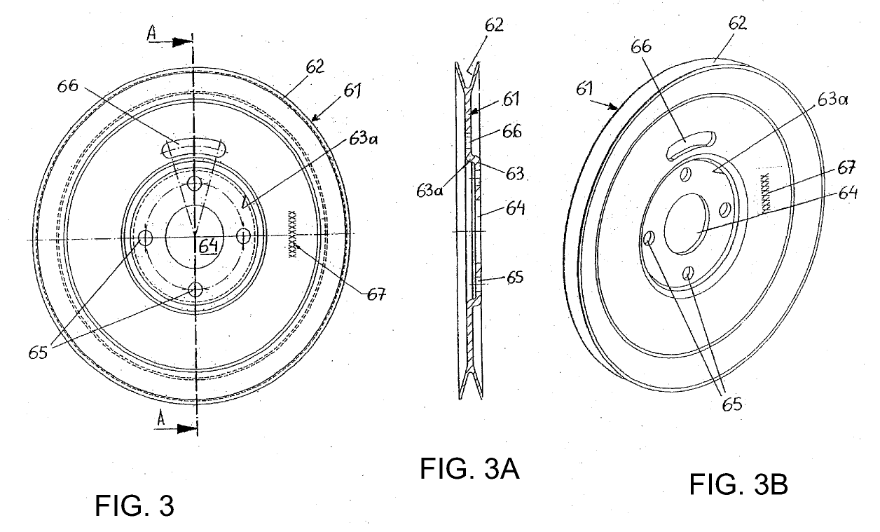

This is achieved in that the pulleys having diameters of different sizes consist of sheet steel, the belt surfaces being produced in that the circumferential rim of the pulley is split, as a result of which an in particular V-shaped groove is produced, forming the belt surface. Two such pulleys which are connected to one another form a pair of pulleys for a belt drive. Such a pulley is represented in FIG. 3, FIG. 3A, and FIG. 3B.

This pulley 61 consists of a circular disk of sheet steel having a thickness of for example 6 mm, which is produced by punching and which is formed with a V-shaped groove 62 along its edge, which is used as a belt surface for a V-belt. This groove 62 is produced by splitting the circumferential rim of the pulley. In its central region, this pulley 61 is formed with a circular-cylindrical bulge 63 or recess 63a by means of a drawing or pressing operation, the depth of said bulge or recess being approximately half the width of the V-groove 62 such that the outer wall of the bulge 63 lies in one plane with the outer edge of the V-groove 62. In the center of the bulge 63, this pulley 61 is formed with a hub 64. Furthermore, the bulge 63 is formed with four bores 65, which are provided for screw bolts. In addition, the pulley 61 is formed firstly with a slot 66, which serves as a viewing window, and secondly on both sides with an inscription 67, which contains details about the size of this pulley 61.

Such pulleys 61 are produced as a set, in a multiplicity of identical widths and identical sizes of the V-shaped groove but with different diameters, and are kept in stock.

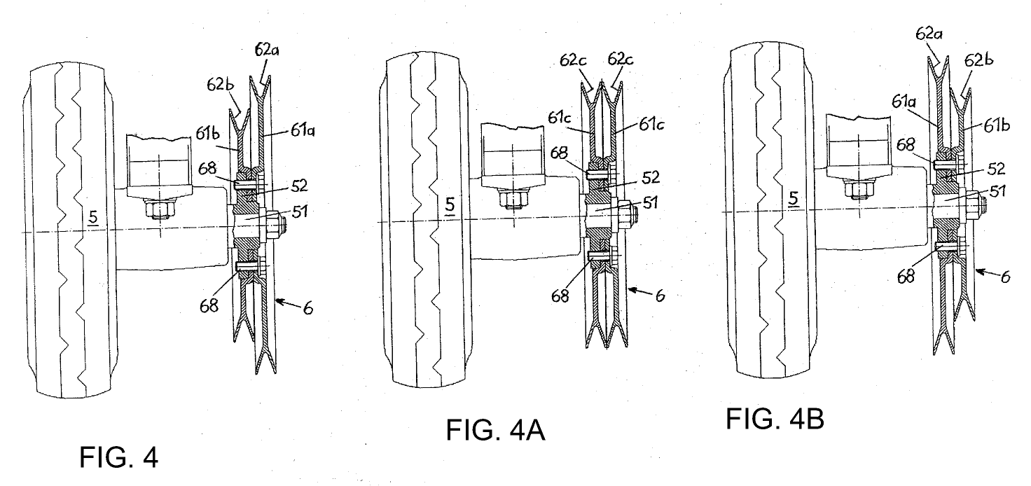

As explained hereafter with reference to FIG. 4, FIG. 4A, and FIG. 4B, in order to produce pairs of pulleys 6, in each case two such pulleys 61 are combined with one another and fitted on the drive shaft 51 for a drive wheel 5.

FIG. 4 shows a first pair of pulleys 6, which consists of two pulleys 61a and 61b, the diameter of the pulley 61a with the groove 62a being much larger than the diameter of the pulley 61b with the groove 62b.

In FIG. 4A, two pulleys 61c with grooves 62c and having identical diameters are combined with one another.

In FIG. 4B, two pulleys 61a and 61b with grooves 62a and 62b are combined with one another, the diameters of the pulleys being identical to those of the pair of pulleys 6 in FIG. 4, but with the pulley 61b being located on the side facing away from the drive wheel 5.

Accordingly, in order to produce pairs of pulleys, in each case two such pulleys 61 are joined with the outer surfaces of the bulges 63 against one another and fitted on the drive shaft 51, which is formed with a flange 52 such that the flange 52 is located in the recess 63a. Furthermore, the two pulleys 61 are fastened to the drive shaft 51 by means of screw bolts 68, which pass through the flange 52. In this case, the mutual orientation of the two pulleys 61 is selected such that the viewing window 66 of the one pulley 61 is located over the inscription 67 of the other pulley 61. The lateral bulge 63 provided in the case of this pulley 61 is used as a spacer between the adjacent pulleys 61. In each case two successive pairs of pulleys 61 of this kind which are coupled to one another by means of a V-belt 7 form a belt drive for the drive wheels 5 in their function as deceleration wheels, conveying wheels and acceleration wheels, respectively.

In addition, it should be pointed out that the pulleys 61 can have about twenty different diameters.

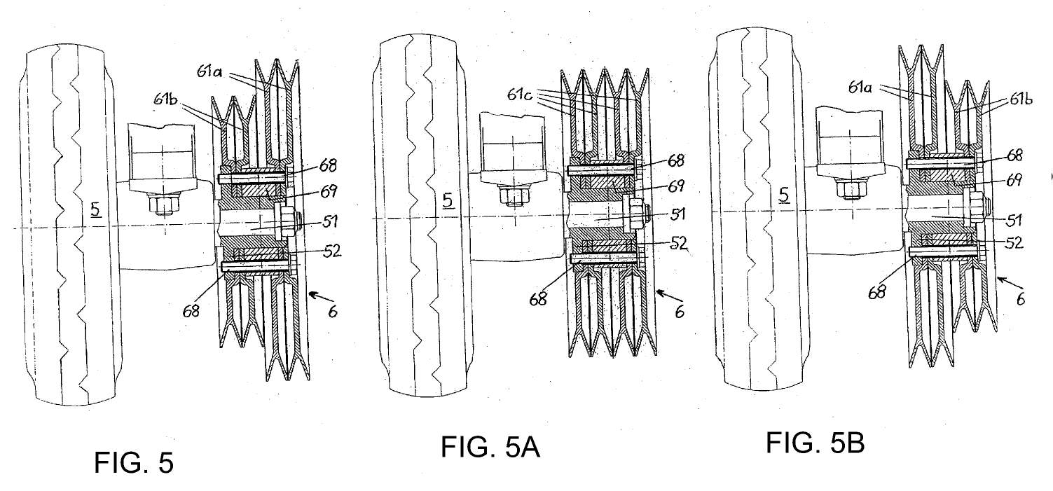

As is furthermore shown in FIG. 5, FIG. 5A, and FIG. 5B, it is also possible to use such pulleys 61 to produce pairs of pulleys for belt drives which are intended for in each case dual drive belts. If four pulleys 61 are combined with one another, it is necessary to insert annular spacers 69 between the two pairs of pulleys 61.

By means of a set of such sheet steel pulleys it is thus possible to produce a multiplicity of pulleys for belt drives, as a result of which the manufacture of pulleys for belt drives can be considerably simplified.

The production of pulleys from sheet steel achieves advantages over production in a casting operation such that much less material is used and furthermore production is much simpler and therefore cheaper.

1. A pulley for a belt drive, comprising:
a pulley body formed of sheet steel, said pulley body having:
a hub, forming a central region of the pulley, for connecting the pulley to a drive shaft;
an annular belt surface, forming a periphery of the pulley, for engagement of a drive belt;
said annular belt surface being formed by a split rim of said pulley body, formed by splitting a periphery of said sheet steel along the rim thereof.

2. The pulley according to claim 1, wherein said split rim is formed into an annular groove.

3. The pulley according to claim 1, wherein said central region is formed with a bulge configured to be fitted on a radial flange of the drive shaft.

4. The pulley according to claim 3, wherein a depth of said bulge in an axial direction is approximately half a width of said belt surface for the drive belt.

5. The pulley according to claim 1, wherein a belt drive is formed by two pulleys being brought into abutment along lateral surfaces of said bulges.

6. The pulley according to claim 1, wherein a belt drive is formed by two adjacent pulleys connected to one another by way of axially directed bolts.

7. The pulley according to claim 1, wherein said pulley body has a through-opening formed therein and an inscription, and wherein said inscription is visible through the opening in an adjoining pulley.

8. The pulley according to claim 1, configured for driving deceleration wheels, conveying wheels, and acceleration wheels in a cableway system.

9. A set of pulleys for producing a belt drive in a cableway system, comprising:
a plurality of pulleys of sheet steel each according to claim 1;
said pulleys having mutually different diameters and configured for optional interconnection.
